(19) United States
(12) Patent Application Publication
(10) Pub. No.: US 2016/0142889 A1
(43) Pub. Date: May 19, 2016

(54) METHODS AND SYSTEMS RELATING TO VISUAL COMMUNICATIONS

(71) Applicant: DIVE COMMUNICATIONS INC., Ottawa (CA)

(72) Inventors: CHELSEA O'CONNOR, OTTAWA K2H 7B5 (CA); JULIAN WHITE, OTTAWA K2H 7B5 (CA)

(21) Appl. No.: 14/896,439

(22) PCT Filed: Apr. 22, 2015
(86) PCT No.: PCT/CA2015/000261

§ 371 Date: Dec. 7, 2015

Related U.S. Application Data
(60) Provisional application No. 61/982,462, filed on Apr. 22, 2014.

(51) Int. Cl. H04W 4/12; G06Q 20/40; G06Q 20/32; G06Q 20/42

(52) U.S. Cl. CPC H04W 4/12; G06Q 20/42; G06Q 20/405; G06Q 20/322

(57) ABSTRACT

The evolution in telecommunications whilst providing email, MMS, SMS, texting etc. still means that telephony is the only telecommunications format providing immediacy in respect of a recipient responding to a message from a sender. Within these other formats the recipient may view the message and elect when to respond thereby allowing them time to compose, consider, etc. rather than garnering their immediate reaction. Accordingly, it would be beneficial to add a level of immediacy to these other forms of telecommunications messaging.

### CROSS-REFERENCE TO RELATED APPLICATIONS

This patent application claims the benefit of World Patent Application PCT/2015/000261 filed Apr. 22, 2015 entitled “Methods and Systems Relating to Visual Communications”, which itself claims priority from U.S. Provisional Patent Application 61/982,462 filed Apr. 22, 2014 entitled “Methods and Systems relating to Visual Communications”, the entire contents of which are incorporated herein by reference.

### FIELD OF THE INVENTION

This invention relates to communications and more particularly to short multimedia message/multimedia message services and short multimedia message/multimedia message communications.

### BACKGROUND OF THE INVENTION

Communication is the activity of conveying information through the exchange of thoughts, messages, or information, as by speech, visuals, signals, written, or behavior. Communication requires a sender, a message, and a recipient, although the receiver does not have to be present or aware of the sender's intent to communicate at the time of initiating communication and hence communications can occur across vast distances in time and space. The communication process is complete once the receiver understands the sender's message.

Communicating with others involves three primary steps. First, thought, wherein information exists in the mind of the sender. Secondly, encoding, wherein a message is sent to a receiver in words or other symbols. Thirdly, decoding, the receiver translates the words or symbols into a concept or information that a person can understand. Telecommunications is communication at a distance by technological means, particularly through electrical signals or electromagnetic waves. Today electrical and electromagnetic telecommunication technologies include telephony, computer networks, radio and wireless transmission, microwave transmission, fiber optic networks, communications satellites and the Internet. These provide the encoding and decoding of information generated by a sender so that it can be presented to the recipient.

For the past 140 years, since its invention, the telephone formed the primary basis for personal telecommunications until the advent of the Internet whilst businesses exploited fax as well as telephony. With the advent of integrated microelectronics, high volume low cost manufacturing, and deployments of wireless infrastructure telephony evolved into mobile telephony where in the past 25 years worldwide mobile telephone subscriptions grew from approximately 12 million to over 6 billion, penetrating about 87% of the global population.

In addition to wireless based telephony, modern mobile telephones also support a wide variety of other services such as text messaging based upon Short Message Service (SMS) protocols, electronic mail (email), Internet access, short-range wireless communication protocols such as infrared and Bluetooth, business applications, photography, gaming, audio streaming, video streaming, and accessing/providing Internet content. Mobile phones that offer these and more general computing capabilities are referred to as smartphones.

However, despite these technological developments primarily the means of communication between individuals are the same as when the telephone was invented. Telephony provides audio communication whilst email, SMS, etc. provide written communications and could be viewed simply as evolutions of the telegraph into a wireless and/or computer based telecommunications infrastructure. However, man has a very highly evolved visual processing system that was developed and exploited before organized verbal communications. Even today, multimedia messaging services (MMS) merely refers to the ability to attach a photograph, for example, to a SMS message.

However, it would be beneficial to provide users with a communications format that leverages their visual sense as well as auditory sense when receiving a message from another user or to allow a user to combine with ease visual and oral content when generating a message for another user. As the adage goes “a picture is worth a thousand words.” Moreover, it would be beneficial to achieve visual communication and receive an honest response or genuine interaction between two or more people without the sender and recipient having to be online at the same time.

The evolution in telecommunications whilst providing email, MMS, SMS, texting etc. still means that telephony is the only telecommunications format providing immediacy in respect of a recipient responding to a message from a sender. Within these other formats the recipient may view the message and elect when to respond thereby allowing them time to compose, consider, etc. rather than garnering their immediate reaction. Accordingly, it would be beneficial to add a level of immediacy to telecommunication messaging.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating to communications and more particularly to short multimedia message services and short multimedia message communications.

In accordance with an embodiment of the invention there is provided a method comprising:
receiving at an electronic device associated with a recipient a message from a sender, the message including a time limit;
automatically acquiring a response comprising audiovisual data upon the electronic device upon presentation of the message for a period of time up to the time limit; and
transmitting from the electronic device the response to the sender.

In accordance with an embodiment of the invention there is provided a method comprising:
receiving at an electronic device comprising a microprocessor associated with a sender a plurality of messages generated by the sender, each message of the plurality of messages having an associated time limit established by the sender;
receiving upon the electronic device data relating to a plurality of contacts selected by the user;
transmitting to a plurality of contacts a message, the message comprising the plurality of messages;
receiving from a predetermined subset of the plurality of contacts responses, each response from a contact within the predetermined subset of the plurality of contacts generated upon an electronic device associated with the contact upon presentation of the plurality of messages and comprising audiovisual data acquired for each message of the plurality of messages for its associated time limit; and
presenting the responses from the predetermined subset of the plurality of contacts responses to the sender.

In accordance with an embodiment of the invention there is provided a method comprising:
receiving at an electronic device comprising a microprocessor associated with a recipient a plurality of messages generated by the sender, each message of the plurality of messages having an associated time limit established by the sender;
generating a plurality of responses, each response being stored upon the electronic device and comprising audiovisual data acquired automatically by the electronic device after the presentation of each message of the plurality of messages to the recipient with a maximum length of acquired audiovisual data associated with a specific message of the plurality of messages being the associated time limit for that message; and
transmitting the plurality of responses from the predetermined subset of the plurality of contacts responses to at least one of a remote server and the sender.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3A depicts user interface screens upon a mobile device to access a short multimedia messaging service (SMMS) according to an embodiment of the invention;

FIG. 3B depicts user interface screens upon a mobile device during message creation within a short multimedia messaging service (SMMS) according to an embodiment of the invention;

FIG. 4 depicts user interface screens upon a mobile device to generate and preview a short multimedia messaging service (SMMS) message according to an embodiment of the invention;

FIG. 5A depicts user interface screens upon a mobile device relating to an initially generated short multimedia messaging service (SMMS) for sending to a user according to an embodiment of the invention;

FIG. 5B depicts user interface screens upon a mobile device relating to a user accessing a generated short multimedia messaging service (SMMS) according to an embodiment of the invention;

FIG. 6 depicts user interface screens upon a mobile device relating to a user playing a short multimedia messaging service (SMMS) message exploiting text based queries and responding according to an embodiment of the invention;

FIG. 7 depicts user interface screens relating to a user playing a reply to a short multimedia messaging service (SMMS) message exploiting text based queries and video responses according to an embodiment of the invention;

FIG. 8 depicts user interface screens relating to a user playing a reply to a short multimedia messaging service (SMMS) message exploiting video based queries and video responses according to an embodiment of the invention;

FIG. 9 depicts user interface screens relating to a user playing a reply to a short multimedia messaging service (SMMS) message exploiting text and video based queries and video responses according to an embodiment of the invention;

FIGS. 10 and 11 depict user interface screens relating to a short multimedia messaging service (SMMS) message exchange exploiting video based queries and responses with multiple parties according to an embodiment of the invention;

FIG. 12 depicts a messaging window providing integrated SMS messaging and SMMS communications within the same user interface according to an embodiment of the invention;

FIG. 13 depicts a messaging window for an SMMS according to an embodiment of the invention received by a recipient indicating a timing deadline for responses to be included;

FIG. 14 depicts user interface screens upon a mobile device to generate and preview a short multimedia messaging service (SMMS) message according to an embodiment of the invention;

FIG. 15 depicts user interface screens upon a mobile device during generation of a short multimedia messaging service (SMMS) message according to an embodiment of the invention within a client domain;

FIG. 16 depicts an interface screens upon an electronic device during generation of a short multimedia messaging service (SMMS) campaign according to an embodiment of the invention within a client domain;

FIG. 17 depicts interface screens upon an electronic device during selection of pre-recorded short multimedia messaging service (SMMS) messages within a client domain for a SMMS campaign according to an embodiment of the invention; and

FIG. 18 depicts an interface screens upon an electronic device during playback of recorded short multimedia messaging service (SMMS) messages within a client domain in response to a SMMS campaign according to an embodiment of the invention.

### DETAILED DESCRIPTION

The present invention is directed to communications and more particularly to short multimedia message services and short multimedia message communications.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals who exploit embodiments of the invention. This includes, but is not limited to, private individuals, employees of organizations and/or enterprises, members of community organizations, members of charity organizations, men, women, children, and teenagers. In its broadest sense the user may further include, but not be limited to, robotic systems, android systems, etc. that may by receipt of an electronic message provide a reply in a format consistent with one provided by a human

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

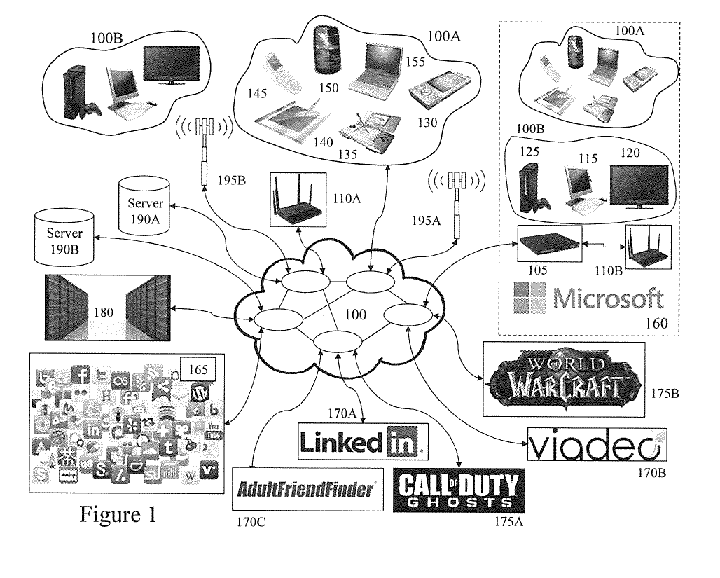

Referring to FIG. 1 there is depicted a network environment 100 within which embodiments of the invention may be employed supporting short multimedia message applications/software/platforms (SMMASPs) according to embodiments of the invention. Such SMMASPs, for example supporting multiple users, multiple formats, and dynamic content. As shown first and second user groups 100A and 100B respectively interface to a telecommunications network 100. Within the representative telecommunication architecture a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, e.g. General Electric™, within which other first and second user groups 100A and 100B are present. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 100A may form associations either through standards such as IEEE 802.15 and Bluetooth as well in an ad-hoc manner.

Also connected to the network 100 are Social Networks (SOCNETS) 165, first and second business networks 170A and 170B respectively, e.g. LinkedIn™ and Viadeo™, adult dating website 170C, e.g. AdultFriendFinder™, and first to second online gaming communities 175A and 175B respectively, e.g. Call of Duty™ Ghosts and World of Warcraft™, as well as first and second servers 190A and 190B which together with others, not shown for clarity. First and second servers 190A and 190B may host according to embodiments of the inventions multiple services associated with a provider of short multimedia message applications/software/platforms (SMMASPs); a provider of a SOCNET or Social Media (SOME) exploiting SMMASP features; a provider of a SOCNET and/or SOME not exploiting SMMASP features; a provider of services to PEDS and/or FEDS; a provider of one or more aspects of wired and/or wireless communications; an Enterprise 160 exploiting SMMASPs; license databases; content databases; image databases; content libraries; customer databases; websites; and software applications for download to or access by FEDs and/or PEDs exploiting and/or hosting SMMASP features. First and second primary content servers 190A and 190B may also host for example other Internet services such as a search engine, financial services, third party applications and other Internet based services.

Accordingly, a user may exploit a PED and/or FED within an Enterprise 160, for example, and access one of the first or second primary content servers 190A and 190B respectively to perform an operation such as accessing/downloading an application which provides SMMASP features according to embodiments of the invention; execute an application already installed providing SMMASP features; execute a web based application providing SMMASP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A. Accordingly, a user exploiting a PED or FED may, via an SMMASP, generate a Short Multimedia Message (SMM) which is transmitted via a SMM Service (SMMS) supported by SMMASPs over one or more networks 100 via one or more wired and/or wireless interfaces to another user exploiting a PED or FED. Within the specification the originating of a SMM or SMMS communication is referred to as the “sender” whilst the receiving user of the sender's SMM or SMMS communication is referred to as the “recipient.” Upon receipt and opening of the SMM or SMMS communication the recipient generates a response to the sender. These exchanges may terminate at this point or they may continue between the sender and recipient. Alternatively, multiple participants may be part of the SMM or SMMS communications.

The sender and recipient may, for example, be members of the same Social Network (SOCNET) or associated Social Networks (SOCNETS) 165 wherein their communications via SMM or SMMS communications may be hosted through the SOCNET/SOCNETs. Within other environments the sender and recipient may be members of a business network, such as first and second business networks 170A and 170B respectively, e.g. LinkedIn™ and Viadeo™, members of an adult dating website 170C, e.g. AdultFriendFinder™, or member of gaming communities such as first to second online gaming communities 175A and 175B respectively for example, e.g. Call of Duty™ Ghosts and World of Warcraft™.

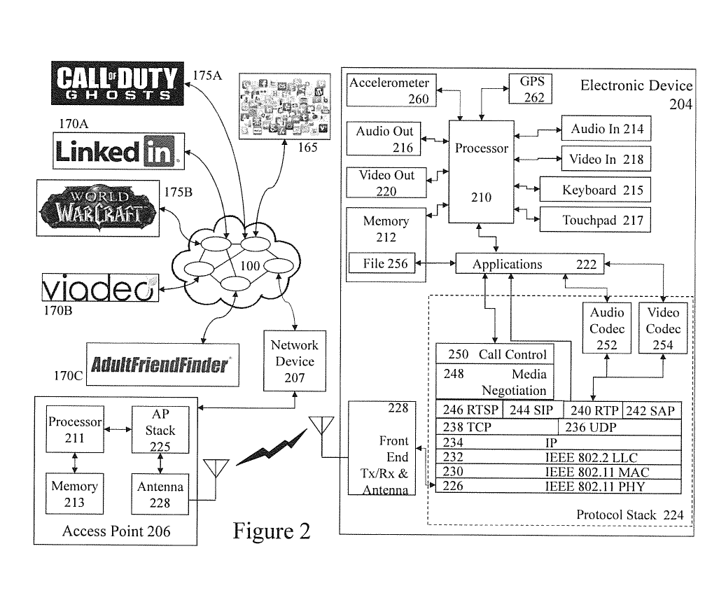

Now referring to FIG. 2 there is depicted an electronic device 204 and network access point 207 supporting SMMASP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein Social Networks (SOCNETS) 165, Social Networks (SOCNETS) 165, first and second business networks 170A and 170B respectively, e.g. LinkedIn™ and Viadeo™, adult dating website 170C, e.g. AdultFriendFinder™, and first to second online gaming communities 175A and 175B respectively, e.g. Call of Duty™ Ghosts and World of Warcraft™.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, nonvolatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

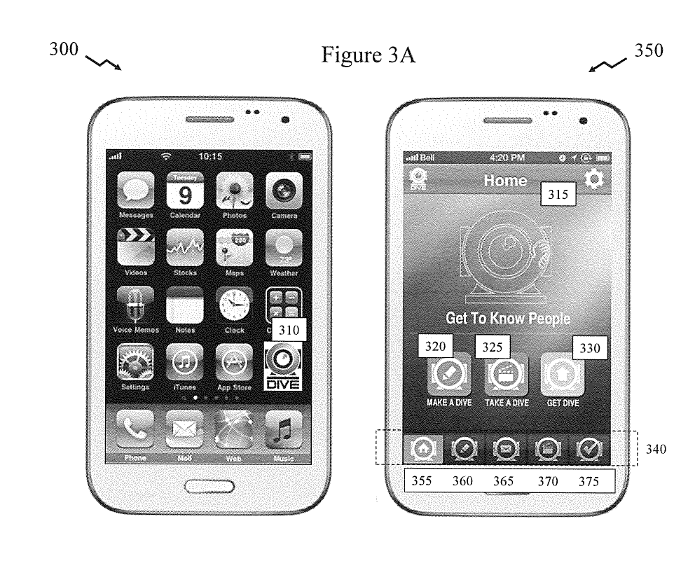

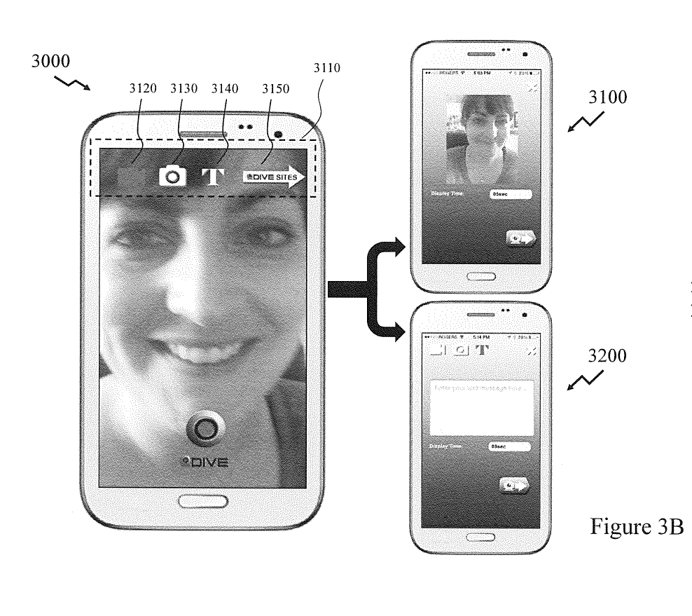

Now referring to FIG. 3A there are depicted first and second user interface screens 300 and 350 respectively upon a PED allowing a user to access a short multimedia messaging service (SMMS) according to an embodiment of the invention. Referring to first user interface screen 300 the SMMS application, in this instance DIVE™, is depicted as an icon 310 which upon selection launches the SMMS application and presents second user interface screen 350 to the user, this being a home screen 315. Within the home screen 315 the user is presented with first to third options 320 to 330 representing starting an SMMS message to a known contact labelled as “MAKE A DIVE”, starting an SMMS message to a contact labelled as “TAKE A DIVE”, and opening a received SMMS message which is labelled as “GET DIVE.” Also presented to the user is a toolbar 340 comprising home icon 355, make icon 360, message icon 365, take icon 370, and complete icon 375 such that selection of these, respectively, take the user back to the home screen (home icon 355), take them to screen to start an SMMS message (make icon 360), take them to a list of SMMS messages (message icon 365), forward to a SMMS message generation screen (take icon 370), and note an action as complete (complete icon 375).

Referring to FIG. 3B there are depicted first to third user interface screens 3000 to 3200 upon a PED during an initial stage of message creation within an SMMASP according to an embodiment of the invention. Upon selection of the make icon 360 the user is presented with first interface screen 3000 wherein the screen becomes an image of the user using the SMMASP through a camera within the PED. Accordingly, the user can see their image and is presented with toolbar 3110 which allows the user to select from first to fourth action icons 3120 to 3150 respectively. These provide the following links:
First action icon 3120 which links to a video based SMMS generator such as depicted in second user interface screen 3100 allowing them to record audiovisual messages;
Second action icon 3130 which links to a camera based SMMS generator which may, for example, be similar to that depicted in second user interface screen 3100 but allowing the user to capture an image of themselves, their environment, an object, another individual etc.;
Third action icon 3140 which links to a text based SMMS generator such as depicted in third user interface screen 3200; and
Fourth action icon 3150 which links the user to “DIVE Sites” which represent one or more “sites” associated with activities of the user with the SMMASP according to embodiments of the invention, wherein this feature may only be accessible to users associated with an enterprise deployment of the SMMASP (e.g. their employer) or to users with an appropriate subscription.

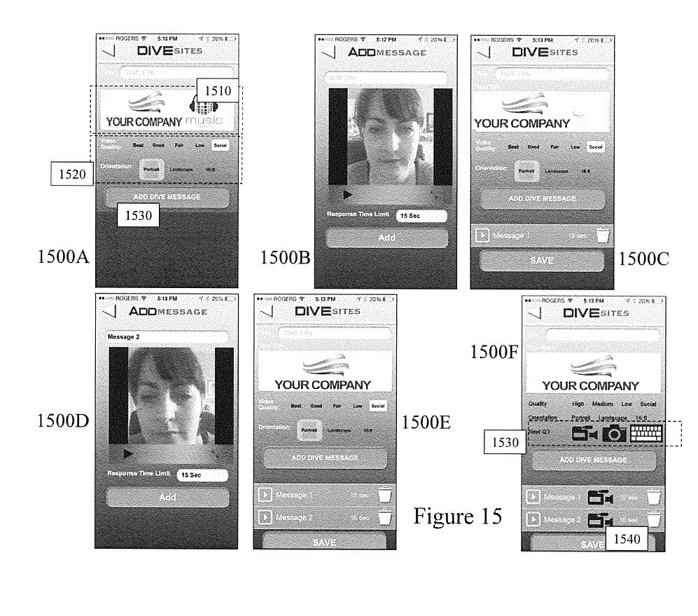

A “DIVE Site” as discussed further in respect of FIGS. 15 to 18 allows a user to manage SMMS messages in defined partitions. For example, a user associated with an enterprise deployment of the SMMASP to their employer, an advertising agency for example, may therefore partition their SMMS messages and activities by client through an associated “DIVE Site” rather than through a set of folders, for example, as employed within the prior art for electronic mail etc. A “DIVE Site” may be partitioned to an individual user, to a group of users or all users of that enterprise. Optionally, a user may be added to a “DIVE Site” by an administrator of the “DIVE Site” such as a new employee, contractor, etc.

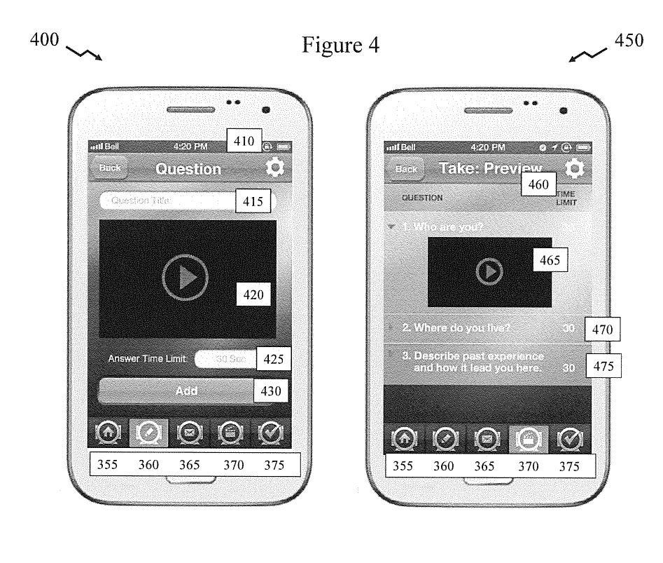

Now referring to FIG. 4 there are depicted first and second user interface screens 400 and 450 respectively upon a PED for a user exploiting an SMMASP allowing a user to access, generate, and reply using SMMS according to an embodiment of the invention. Within first interface screen 400 the user has selected an icon to generate an SMMS message within an SMMS application according to an embodiment of the invention, e.g. DIVE™ from Dive Communications. Accordingly, the user may have selected first option 320 “MAKE A DIVE” in second user screen 350 in FIG. 3. This presents a query screen 410 allowing the user the option to select to enter a message title via entry field 415 or a video message which is displayed a video screen 420. The user can then select a duration for the response to be provided by the recipient(s) with duration field 425 and then whether to add a further message via add button 430. The user then may select icon 375 identifying the generation of the SMMS as complete wherein they are then presented with a menu of contact or search options in respect of whom to send the SMMS to. This menu not being shown as such options are known within the prior art. Alternatively, prior to the selection of contacts the selection of icon 375 may lead to the user being presented with second user interface screen 450 wherein the user may preview their SMMS. As such there are depicted in this exemplary SMMS review screen 460 there are depicted first to third messages 465 to 475 respectively wherein the first message 465 is shown with its message title “Who Are You” and short multimedia message (SMM). Second and third messages 465 and 470 are shown by their message titles “Where do you live” and “Describe past experience and how it lead you here”. If the user selects either of the second and third messages 465 and 470 respectively then the screen adjusts so that the user can see the associated SMM with each. If in the preceding generation of the SMMS was completed without one or more of the messages having a SMM associated with it then the display in second user interface screen 450 may not show the arrow icon or may display a different icon to indicate that there was no associated SMM to the message. Also depicted adjacent to each of the first to third messages 465 to 475 respectively are time limits for the responses, in this instance 30 seconds.

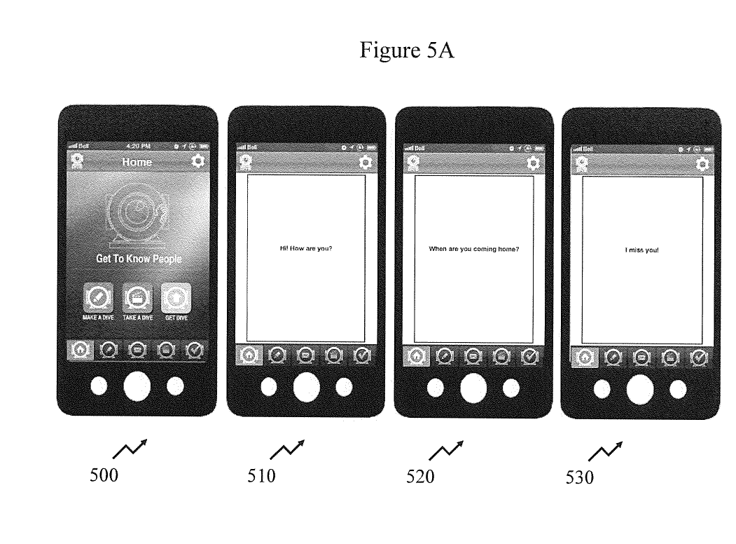

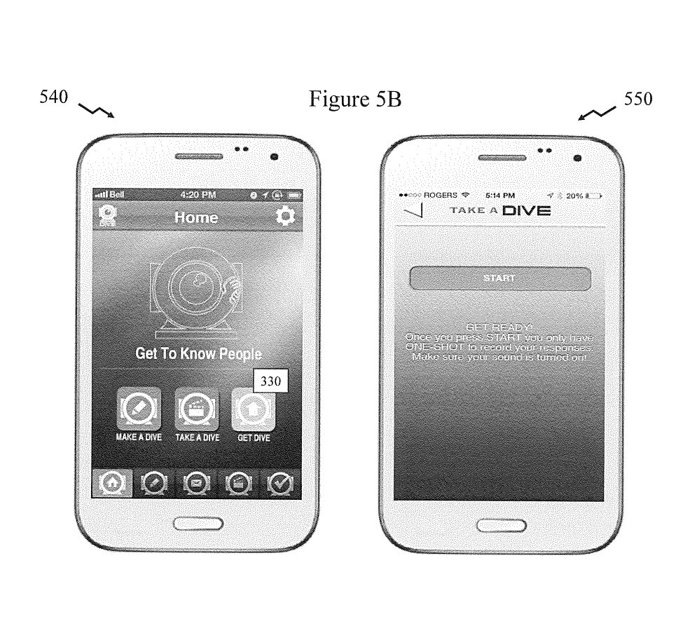

Accordingly referring to FIG. 5A a user has generated a SMMS with three text based messages as depicted by first to fourth screens 500 to 530 respectively wherein first screen 500 depicts a launch screen whilst second to fourth screens 510 to 530 respectively each depict a message screen within the generated SMMS message from the sender. In this instance the sender has not generated any SMM content as part of the SMMS message. Optionally, a different screen may be presented as launch screen 500 such as a screen depicting an image of the sender with a title of the message generated by the sender which forms part of an identifier for the SMMS thread. Optionally, the launch screen 500 may present an overview of an SMMS thread so that the user can decide whether to view the whole thread in order, simply view this portion (latest chronological) element of an SMMS thread, or whether they wish to only view the portions of this latest element of an SMMS thread generated by the other user in response to their queries. In this manner, the user may view the whole SMMS thread, a portion of the SMMS thread, their messages and the responses, or just the responses. Optionally, such aspects may also be part of a user configuration for the SMMASP generated when they initially download and utilize either a SMMASP directly or software/application exploiting SMMASP features.

FIG. 5B depicts first and second user interface screens 540 and 550 upon a PED relating to a user accessing a generated SMMS within a SMMASP according to an embodiment of the invention. As depicted first user interface screen 540 corresponds to launch screen 500 in FIG. 5A and home screen 315 in FIG. 3A wherein now the user has selected the “GET DIVE” icon, third option 330, associated with opening a received SMMS message. Accordingly, prior to opening the message a “warning” screen is displayed to the user as depicted in second user interface screen 550. This “warning,” which may in some instances be disabled by the user through the settings after a predetermined number of displays, advices the user that once they press the “START” icon to play the SMMS that they only have one shot (one chance) to record their response and to ensure that their sound is turned on. As described supra a significant aspect of the SMMS/SMMASP according to embodiments of the invention is to add the immediacy of a face-to-face conversation to an electronically delivered and responded to message. As such when the user presses “START” the message from another user is played such as described and depicted below in respect of FIGS. 5A, 6 to 9, 11, and 15-18. Accordingly, as soon as a message segment from the other user is completed the user's PED is active in respect of camera and microphone to record the user's response with the predetermined duration set in the sent message. In this manner the sender receives the recipient's immediate response and reaction.

Within embodiments of the invention the response from the user may be sent based upon a trigger event within the SMMASP associated with the SMMS. For example, the trigger may be the user completes recording the response(s) to the message(s)/comment(s) from the sender within SMMS. Optionally, the trigger may be that the user has not completed within a predetermined time, that the user quits the SMMASP, exits the current SMMS, etc.

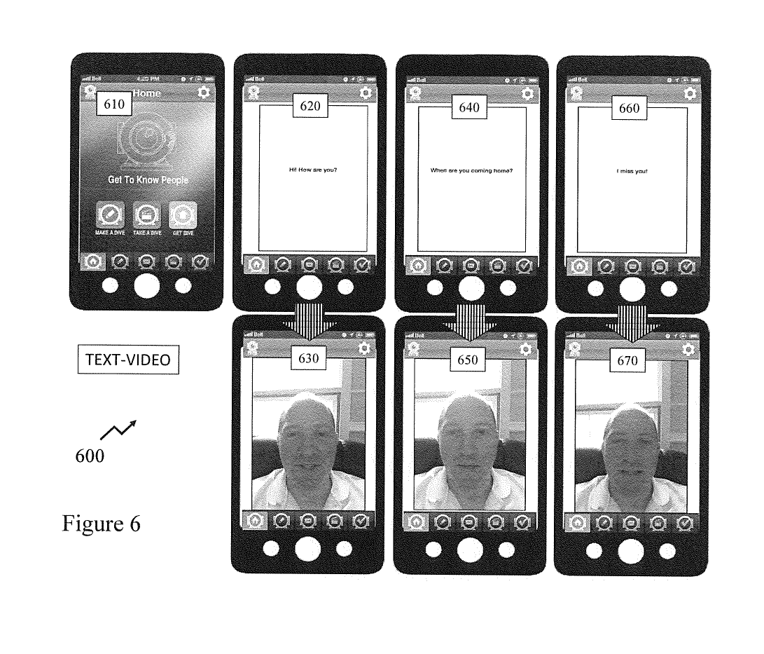

When the recipient receives the SMMS and open it the user is initially presented with launch screen 610 as depicted in FIG. 6 which is then followed by first message screen 620 where the sender presents their first message to the recipient. The recipient is then presented with first response screen 630 which shows the video image being captured as they respond. Optionally, they may also be presented with a timer showing the portion of the allotted time, e.g. 30 seconds, 1 minute, 10 seconds etc. they have currently generated. Alternatively, the allotted time may be presented to the user. Once the allotted time expires or the recipient taps the touchscreen of their PED, selects a button, icon, etc. to denote completion of their response then the user is then presented with second message screen 640. By repeating these steps therefore the recipient generates responses in second and third response screens 650 and 670, the latter being after third message screen 660. Once the response from the recipient is complete with their third response then the generated response is transmitted back to the sender via the network 100.

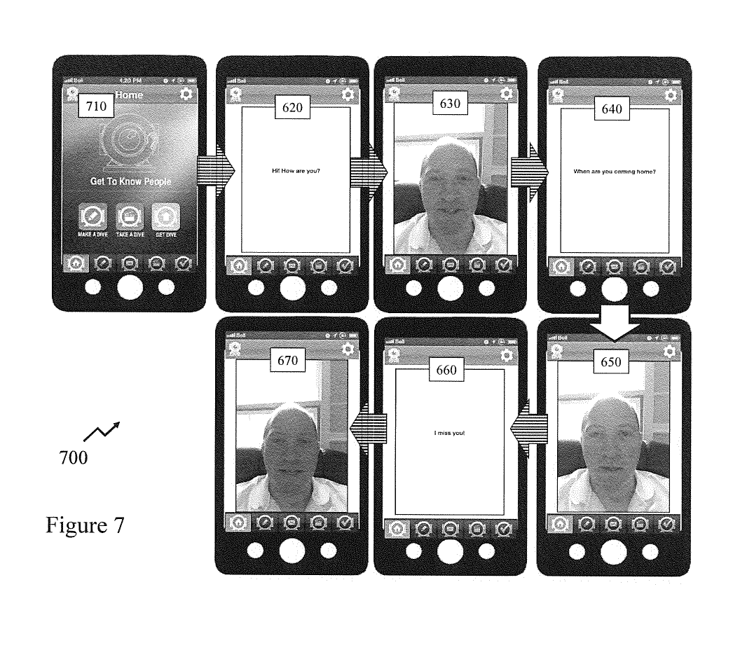

Upon receipt and opening by the sender they are presented, as depicted in FIG. 7 user interface screens relating to a user playing a reply to a short multimedia messaging service (SMMS) message exploiting text based queries and video responses according to an embodiment of the invention. As depicted in simulated flow 700 the user is presented with the SMMS message comprising launch screen 610 and then in the correct sequence first message screen 620, first response screen 630, second message screen 640, second response screen 650, third message screen 660, and third response screen 670. Optionally, a different screen may be presented as launch screen 710 such as a screen depicting an image of the sender with a title of the message generated by the original originating sender which forms part of an identifier for the SMMS thread. Optionally, the launch screen 710 may present an overview of an SMMS thread so that the recipient opening it can decide whether to view the whole thread in order, simply view this portion (latest chronological) element of an SMMS thread, or whether they wish to only view the portions of this latest element of an SMMS thread generated by the other user in response to their queries. In this manner, the user may view the whole SMMS thread, a portion of the SMMS thread, their messages and the responses, or just the responses. Optionally, such aspects may also be part of a user configuration for the SMMASP generated when they initially download and utilize either a SMMASP directly or software/application exploiting SMMASP features.

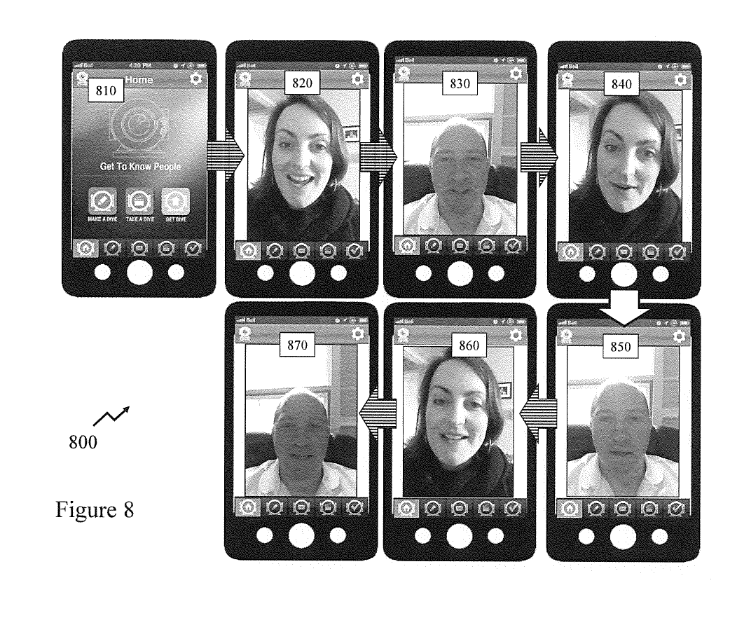

FIG. 8 depicts user interface screen sequence relating to a user playing a reply to a short multimedia messaging service (SMMS) message exploiting video based queries and video responses according to an embodiment of the invention. As depicted in simulated flow 800 the user is presented with the SMMS message comprising launch screen 810 and then in the correct sequence first message screen 820, first response screen 830, second message screen 840, second response screen 850, third message screen 860, and third response screen 870. Each of the first to third message screens 820, 840, and 860 and first to third response screens 830, 850, and 870 are a SMM generated by the respective party.

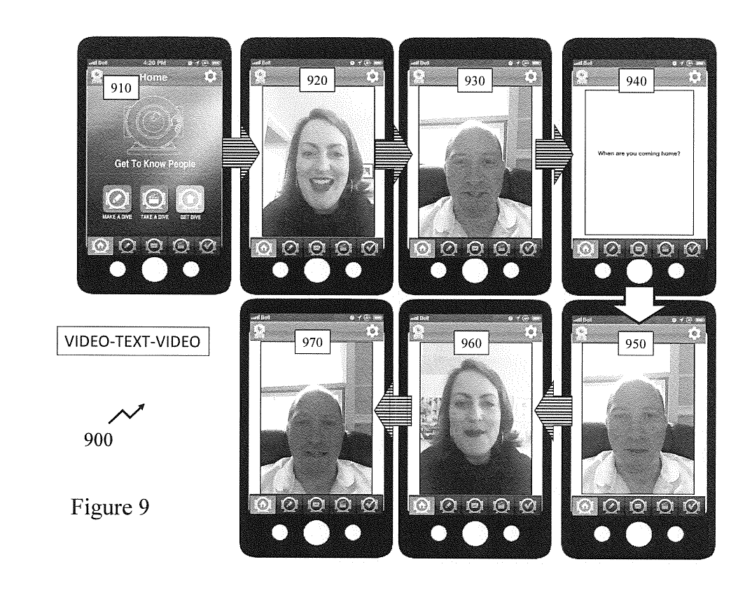

Now referring to FIG. 9 there is depicted a user interface screen sequence relating to a user playing a reply to a short multimedia messaging service (SMMS) message exploiting video and text based queries and video responses according to an embodiment of the invention. As depicted in simulated flow 900 the user is presented with the SMMS message comprising launch screen 910 and then in the correct sequence first message screen 920, first response screen 930, second message screen 940, second response screen 950, third message screen 960, and third response screen 970. Each of the first and third message screens 920 and 960 and first to third response screens 930, 950, and 970 are a SMM generated by the respective party. Second message screen 940 being a text message screen.

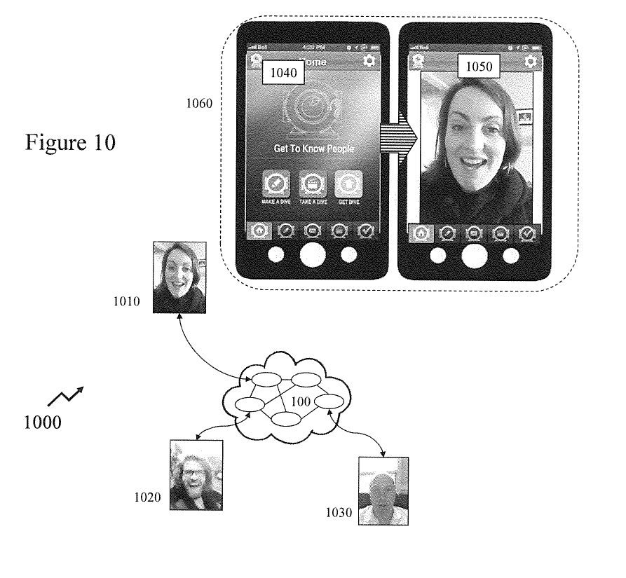

Referring to FIGS. 10 and 11 there are depicted user interface screens relating to a short multimedia messaging service (SMMS) message exchange exploiting video based queries and responses with multiple parties according to an embodiment of the invention. Accordingly, as depicted in FIG. 10 a sender 1010 generates a SMMS 1060 comprising launch screen 1040 and video message 1050 which is then transmitted to first and second recipients 1020 and 1030 respectively via the network 100. Accordingly, each of the first and second recipients 1020 and 1030 generates their response to the SMMS which is then transmitted back via the network 100 to the sender 1010. As such first recipient 1020 generates first response 1160 and second recipient 1030 generates third second response 1170. As a result as depicted in FIG. 11 the sender 1010 receives a first SMMS 1110 which comprises their video message 1050 together with the first and second responses 1160 and 1170 from the first and second recipients 1020 and 1030 respectively. If the sender 1010 had sent the SMMS to both of the first and second recipients 1020 and 1030 respectively then they each receive each other's responses such that first recipient 1020 receives second SMMS 1120 comprising video message 1050 and second response 1170. Similarly, second recipient 1030 receives third SMMS 1130 comprising video message 1050 and first response 1160. Optionally, each of the first and second recipients 1020 and 1030 may have received the same message as sender 1010, namely first SMMS 1110 containing all responses and the original query.

Within other embodiments of the invention features comparable to the carbon copy (cc) and blind carbon copy (bcc) may be supported in addition to the direct message (e.g. those within the “to” list of contacts to whom the SMMS is distributed). Optionally, the functionality of the SMMASP provided to a recipient may vary according to whether the recipient was on the “to” list or upon either of the “cc” and “bcc” lists in conjunction with another recipient's response being “reply all” or simply “reply.” In the “reply” and “reply all” scenarios then for users on the original “to” list then they receive a copy of the responses from all recipients when the other recipients replies irrespective of whether recipient selected “reply” or “reply all” whilst those on the original “cc” list only see responses for “reply all.” Those on the “bcc” list only see the original message or the original message and all replies with “reply all.”

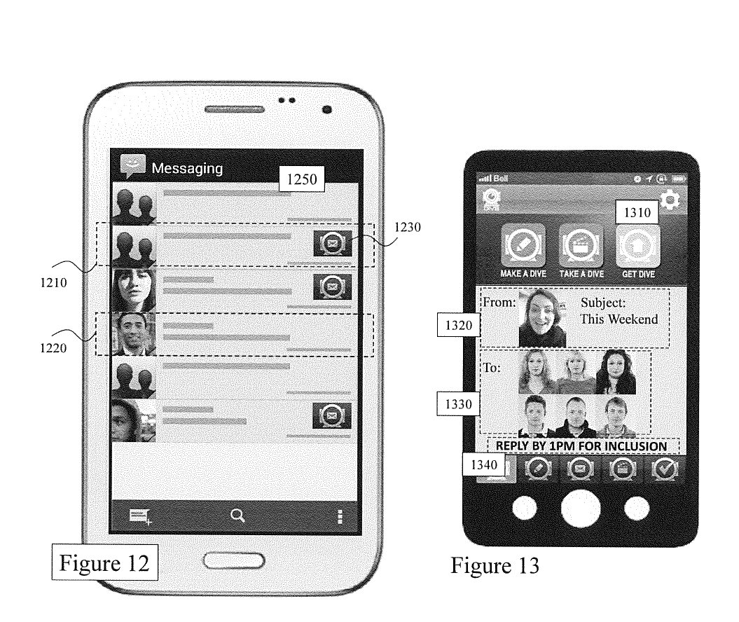

Optionally, in order to avoid a sender becoming overloaded with responses where the number of recipients is large then as depicted in FIG. 13 the sender may select in generating the message a “Reply By” feature such that only responses generated prior to the deadline are included within the message provided to the sender. Accordingly, in the message provided to the recipients upon launch then screen 1310 is displayed showing an image of the sender together with the subject line of the message in field 1320. Also displayed are images of the recipients within a “To” field 1330 and a deadline field 1340. As shown the recipients are notified that they have until 1 pm for their response to be included. Accordingly, at the deadline the responses from all those recipients who have responded are combined and provided to the sender such that the sender receives only one consolidated response. The order of the responses within the consolidated response may be, for example, based upon the order of the users within the original SMMS message address list(s) or be time based so that they are depicted in the order that the recipients responded.

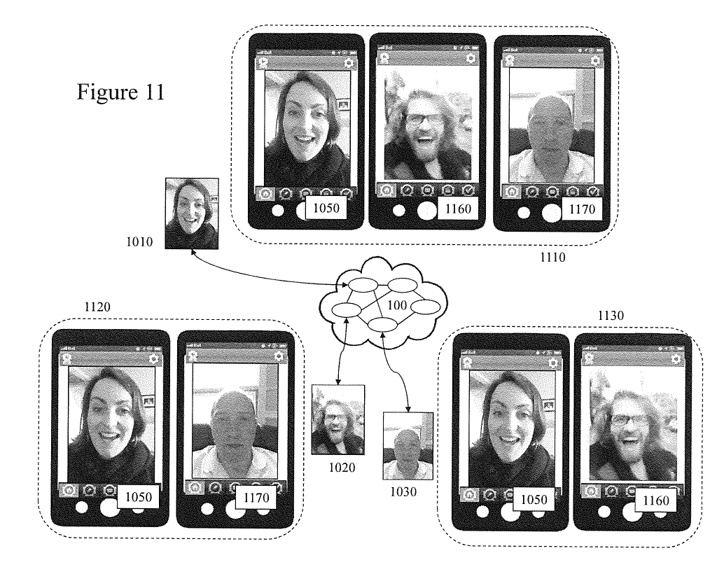

It would be evident that an SMMASP may form part of another messaging application or an application consolidating multiple messaging systems to provide a coherent interface for the user. Such an example is depicted in FIG. 12 wherein a messaging window 1250 is shown providing integrated SMS messaging and SMMS communications within the same user interface according to an embodiment of the invention. As such the user has received an SMMS message 1210 and an SMS message 1220 and these are displayed as part of the consolidated list of messages. Additionally the SMMS message 1210 includes an icon 1230 indicating that the message was from an SMMS application, e.g. DIVE™.

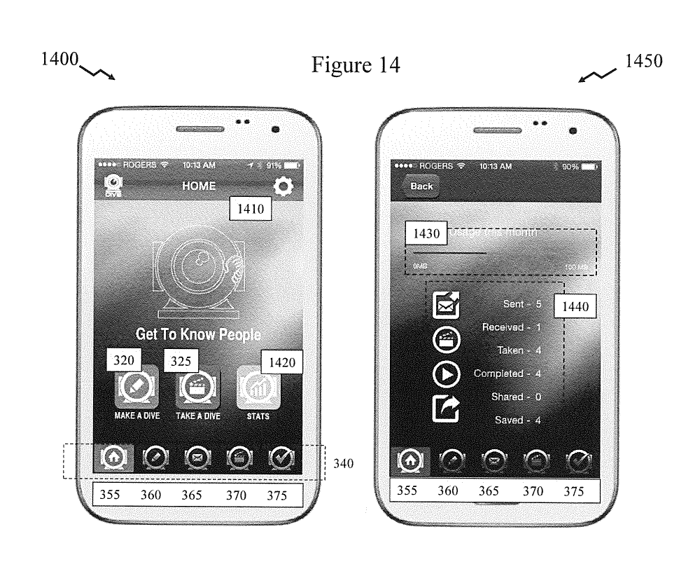

Now referring to FIG. 14 there are depicted first and second user interface screens 1400 and 1450 respectively upon a PED for a user exploiting an SMMASP allowing a user to access, generate, and reply using SMMS according to an embodiment of the invention. Within first interface screen 400 the user is presented with a home screen 1410 the user is presented with first to third options 320, 325 and 1420 representing starting an SMMS message to a known contact labelled as “MAKE A DIVE”, starting an SMMS message to a contact labelled as “TAKE A DIVE”, and obtaining details of SMMS messages which is labelled as “STATS.” Also presented to the user is a toolbar 340 comprising home icon 355, make icon 360, message icon 365, take icon 370, and complete icon 375 such that selection of these, respectively, take the user back to the home screen (home icon 355), take them to screen to start an SMMS message (make icon 360), take them to a list of SMMS messages (message icon 365), forward to a SMMS message generation screen (take icon 370), and note an action as complete (complete icon 375).

If the user selects third option 1420 then they are presented with second user interface screen 1450 which presents a usage indicator 1430 allowing the user to quickly visualize their usage and statistics list 1440 comprising, for example, a list of DIVE's sent, received, taken, completed, shared, and saved. Optionally, other options may be presented, such as filtering by recipient, enterprise, project etc. or accessing directories which are associated with specific recipients, enterprises, projects etc. as established by the user.

Referring to FIG. 15 there are depicted first to fifth user interface screens 1500A to 1500E upon a PED during generation of a short multimedia messaging service (SMMS) message according to an embodiment of the invention within a “client domain” or “DIVE Site” (DIVE Site). Accordingly, the user accesses the DIVE Site, for example via fourth action icon 3150 in first user interface screen 3000 in FIG. 3B. They are then presented with site list 1510 which in this instance is populated with “Your Company” and “Music Company” although more options may be presented graphically through a scrolling window or through drop-down menus, pop-up menus, etc. as known in the art. Optionally, multiple selections may be required or presented such as in the instance that an enterprise selected, e.g. “Your Company” has multiple divisions, advertising campaigns, etc. associated with it. Before or after selecting the DIVE site then the user may select message format settings in setting window 1520 including, for example as depicted, the quality of the video and the orientation/aspect ratio of the message. Quality may, for example, be best, good, fair, low and social wherein “social” may for example be configured by the social media website dynamically. The user then selects Add Dive Message 1530 wherein the user navigates through second to fifth user interface screens 1500B to 1500E respectively wherein the user generates first and second messages as part of the SMMS and may either stop and save or add more messages. After each message is added the user has the options to save or add another message presented to them. The user can also add a title to the SMMS they generate for ease of subsequent referral.

The process depicted in first to fifth user interface screens 1500A to 1500E respectively represents an example of a SMMS message generation sequence within an SMMASP with video based messages rather than a text based message as depicted and described in first to fourth screens 500 to 530 respectively in FIG. 5A above. It would be evident to one skilled in the art that the user may also generate an image based message through a similar process such as described in respect of FIGS. 5A and 15 respectively. Within other embodiments of the invention the user may be presented with the option to select a different format for each message such as depicted within sixth user interface screen 1500F wherein the user now has format toolbar 1530 with options for video (audiovisual), image, and text. Also each message now includes an icon 1540 indicating its format. In this manner, a user may create a DIVE, for example, with a video message, followed by an image, followed by another video. It would be evident that other sequences could be implemented according to the message being provided by the sender.

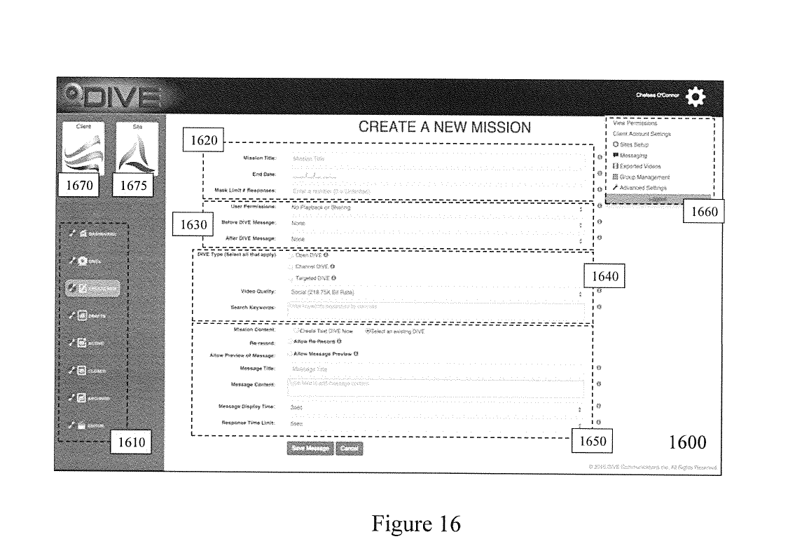

Now referring to FIG. 16 there is depicted an interface screen 1600 upon a FED, typically, during the generation of a SMMS (SMMS) campaign according to an embodiment of the invention within a client domain (DIVE site). As depicted the interface screen 1600 is associated with an administrator through the provisioning of administration menu 1660 in addition to the menu bar 1610 and dashboard area comprising mission details 1620, user permissions window 1630, DIVE window 1640 and mission content window 1650 respectively. Administration menu 1660 provides a user with the ability to set and establish permissions of other users, set client account settings, establish client sites (DIVE sites), employ SMMS, access exported videos, manage groups and access more advanced settings as well as log out.

Menu bar 1610 allows the user to view a top level dashboard, access DIVEs (SMMSs), create a new mission, view drafted missions prior to publication, view active missions, view closed missions, view archived missions, and edit missions. Within a context of the SMMASP a mission is an SMMS issued to a plurality of recipients. Examples of such missions may be customer surveys, sales pitches, etc. Within the interface screen 1600 the user has selected to create a new mission within the menu bar 1610 such that now the displayed windows provide the following features:

Mission details 1620 which comprises fields relating to the mission. These may include, for example:
Mission title;
End date of mission (optionally may be date/time allowing for example short term missions, e.g. 1 hour, or extended missions with define cut-offs, e.g. ends December 31 at 11:59); and
Mask limit for the number of responses so that, for example, the first 10 responses, 100 responses, 5,000 responses are captured.

User permissions window 1630 which comprises fields relating to user permissions and overall message structure. These may include, for example:
User permissions, such as can the recipient share, playback, etc.;
Is there a mission element to be added prior to the SMMS message, such as a short video, advertisement etc.; and
Is there a mission element to be added after the SMMS message, such as a coupon, offer, short video, thank you closing etc.

Accordingly, with the user permissions window 1630 a user, e.g. a salesperson, may generate their own SMMS which forms part of an overall enterprise based communications mission. For example, a special invitation by Honda™ may include a corporately prepared introduction and closing but has a section created by each consumer's sales contact, i.e. a personal message from a face they recognise.

DIVE window 1640 which allows the SMMS to be configured, including for example:
SMMS type, which may be an open SMMS (accessible to all), a channel SMMS (distributed to only those within a channel, e.g. all Adobe Creative Cloud registered users), and a targeted SMMS (e.g. only those users associated with the salesperson);
Video quality setting; and
Search keywords that the user wishes to associate with the SMMS so that the SMMS can be found within an email system, website, etc.

Mission content window 1650, which provides the user with the ability to add/amend configurations of the SMMS as part of the mission, including for example:
Mission content, allowing the user to create an SMMS or retrieve an existing SMMS;
Re-record, wherein a recipient may be offered the ability to re-record a response or may be denied such an option;
Preview, wherein a user may be offered the ability to preview a message prior to responding or may be denied such an option (optionally this may be extended with the option for single preview, multiple previews etc);
Mission message title;
Message content, in respect of is there any associated message in text for with the SMMS such as for example an email may be sent with the SMMS as an attachment or the message may be presented prior to the message being played;
Message display time, e.g. how long is a message or image/text presented; and
Message reply time limit, which sets the duration of the recipient's response either per message/element or in total.

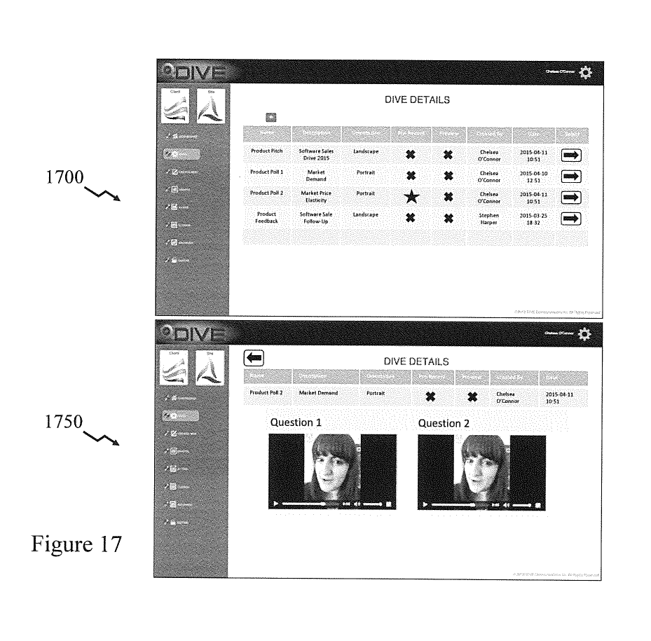

Accordingly, a user of an SMMASP within an enterprise version may create and manage a plurality of missions associated with a single channel site or with multiple channel sites. As depicted in FIG. 16 the user is working within a channel, depicted by client 1670, and a division, depicted by site 1675. For example, a marketing/advertising/sales team may within the enterprise work upon multiple missions for the different divisions, products, etc. or if external, such as an agency, may work for multiple clients and multiple missions with each client. All of these can be managed through a common enterprise portal of which the user interface screen 1600 in FIG. 16 represents an example thereof. Now referring to FIG. 17 there are depicted first and second interface screens 1700 and 1750 for a user within an enterprise SMMASP according to an embodiment of the invention. Within first interface screen 1700 the user has selected to view existing DIVEs (SMMS existing already). As such they are presented with a list of these with key information such as name, description, orientation, are re-records or previews allowed, who created it, when it was created and a selection button to access the SMMS which when selected triggers a second user interface screen 1750. This shows the selected SMMS in more detail. As depicted this includes showing the SMMS elements which can be individually selected and viewed.

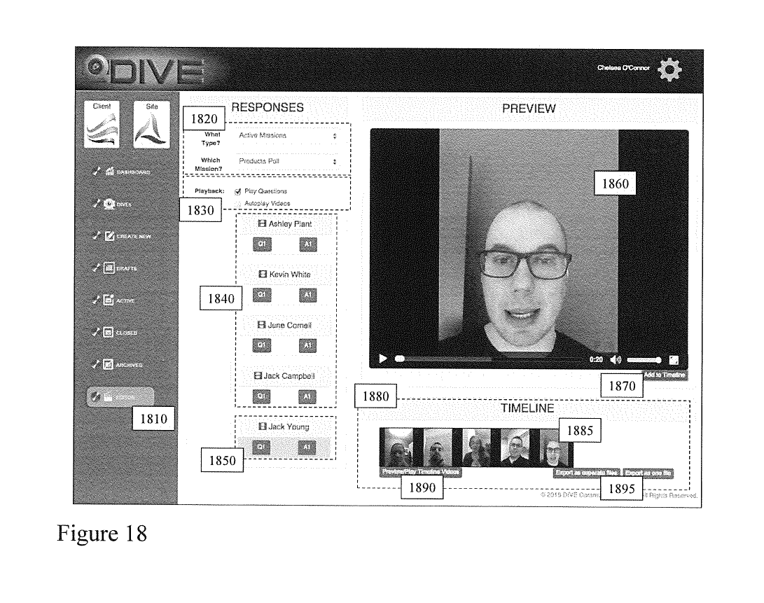

Once a mission such as described supra in respect of FIGS. 16 and 17 has been generated and released then a user may through a user interface screen such as depicted in FIG. 18 view and playback of recorded SMMS message replies from recipients of the SMMS distributed to them. This may, for example, be via selection of the editor option within the menu bar 1610 within interface screen 1600 in FIG. 16, denoted by highlighted button 1810. Upon selection of the SMMS to view responses from then their dashboard changes to depict response selector window 1820, playback window 1830, reply list 1840, active reply 1850, SMMS response 1860, and a timeline 1880 together with first to third buttons 1870, 1890 and 1895. These different elements provide, for example:
Response selector window 1820, wherein the user can select what to filter missions such as, for example all active missions, completed missions, pending missions etc. and then within these categories filter for mission type, e.g. product poll, product feedback, sales pitches, etc.;
Playback window 1830, which allows the user to display the message or just responses and whether to autoplay responses in sequence;
Reply list 1840 which lists replies by user identifier and completed elements, such that for example if an SMMS had 2 messages then whether the recipient replied to one or both messages may be established either through length of reply associated, whether the reply is silent, etc.;
Active reply 1850, which highlights the currently playing SMMS displayed in SMMS response 1860;
SMMS response 1860, wherein the user can view the current SMMS response;
Timeline 1880 wherein the user may select specific user SMMS responses in part or whole to build a timeline comprising SMMS responses that a relevant/appropriate such that they can filter out rubbish, good responses etc.;
First button 1870 which allows a user to tag the current SMMS response element for inclusion within the timeline 1880;
Second button 1890 which allows the user to play/preview the timeline SMMS responses; and
Third button 1895 which allows the user to export the select SMMS responses as separate files or a single file.

Whilst the user interface screen depicted in FIG. 18 for viewing and playback of recorded SMMS message responses is presented in respect of video (audiovisual). However, it would be evident that alternatively the SMMS responses may be images or text or a combination of formats where different formats are employed within a single SMMS.

Within FIGS. 1 to 18 described and presented supra in respect of embodiments of the invention a variety of SMMS/SMMASP have been presented relating to establishing communications between remote sender and recipient that are closer face-to-face communications and provide for immediacy of providing a message or information and obtaining a response without the recipient being able to compose, re-compose, edit or amend their replies in most instances. Some embodiments may provide for previewing or second recording. Accordingly, such SMMS communications may be employed in a wide range of applications including, but not limited to:
Purchase Validation: i.e. an e-commerce company is looking to capture an instant message from the purchaser just prior to authorizing their payment where the message may be an approval stored for subsequent retrieval in the event of a dispute or may be processed for verbal or facial action etc.;
Character Validation, i.e. if a company wants to assess an individual prior to making an introduction or meeting etc.;
Personals, online dating etc., i.e. if a user wants to capture the instant response from another user to determine the validity, character, or level of attraction to the person prior to meeting them in person etc.;
Improvisation, i.e. for a human resources company to test an applicant on their ability to improvise in a specific scenario, for a comedy troupe to be able to create videos that test the improvisation talents of the cast, or for an enterprise to run a competition etc.;
Inter-company communications, i.e. if a manager wants to get instant feedback from their employees about where they are at or what they are doing or their thoughts about a specific action, task, request, etc.;
Digital media companies, i.e. looking to conduct an interview asynchronously but still capture the first response of the interviewee;
Production companies/broadcasters etc., i.e. looking to capture the genuine nature of persons character, environment, or surroundings for the purpose of casting;
Market research/contest offerings, i.e. if a company wants to make a special offer to their customers and limit the time in which they are able to respond to the promotion or advertisement after it has been delivered to the customer or seek their feedback, comment, observation etc.; and
Geo-Location, i.e. a response is geo-tagged.

Optionally, a SMMS to a recipient may be geo-tagged or geo-fenced such that it is only provided if they are within a predetermined geographical location or boundary.

Optionally, a SMMS to a recipient may include a trigger to download and install an SMMASP onto the user's PED, for example, upon their initial acceptance of receiving the SMMS, for example.

Accordingly, it can be seen from the descriptions of the embodiments of the invention described supra in respect of FIGS. 1 to 14 respectively that SMMS messages may be supplied directly between users or they may be routed, stored, and distributed through servers associated with an SMMASP providing the SMMS or an application/software suite etc. that includes SMMASP elements to provide SMMS features as part of the overall product offering. It would be evident that the sender within the embodiments of the invention described supra may generate an SMMS message comprising one or more messages with text and/or video elements to which the recipient replies with a video response generated immediately thereafter such that in a similar manner to a telephone conversation the recipient's immediate response is acquired. Optionally, a short timer, e.g. 5 seconds, may be indicated prior to the user's PED/FED camera being activated and their response acquired until either indicated as complete by the user or the allotted time has expired.

Within the embodiments of the invention described supra in respect of FIGS. 1 to 14 respectively the responses of recipients have been described as being video. Alternatively, the camera of the PED/FED may acquire an audio stream in conjunction with an image or images rather than a video stream.

Within the embodiments of the invention described supra in respect of FIGS. 1 to 14 respectively the messages have been described as being either text or video. Alternatively, a message may comprise an audio message solely or an audio message in association with an image or images added by the sender.

Within the embodiments of the invention described supra in respect of FIGS. 1 to 14 respectively the responses of recipients have been described as comprising an SMMS which includes the sender's messages and recipient's responses. Alternatively, as the sender generated the messages and other recipients received the messages then the responses send by each recipient may comprise only their responses such that the construction of the message—response sequence is undertaken at each PED/FED or a server prior to transmission such that network loading is reduced from a recipient's PED/FED.

Whilst embodiments of the invention have been described with respect to what the inventors have referred to a short multimedia messaging services (SMMS) it would be evident that whilst in, for example, a social version the messages between sender and recipient may be short the overall message may become long as the conversation develops in some embodiments of the invention. This extension into longer messages will occur also more rapidly with the collation and merging of conversation threads such as described supra in respect of embodiments of the invention. It would also be evident that embodiments of the invention may extend the maximum duration available for replying to a senders message or response. Such an extension may, for example, be provided for subscribers at a premium level or perhaps within a commercial/business network. Accordingly, the use of the term “short” within the context of the invention should not be construed as limiting the duration of at least one of the initial message, combined messages of senders and recipients, combined messages of collated conversations, individual messages, and individual responses.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
receiving at an electronic device associated with a recipient a message from a sender, the message including a time limit to be associated with a response;
automatically acquiring with the electronic device a response comprising response data upon the electronic device upon presentation of the message for a period of time up to the time limit; and
transmitting from the electronic device the response to the sender.

2. The method according to claim 1, wherein
recording of the response begins automatically upon completion of at least one of the message and a predetermined portion of the message.

3. The method according to claim 1, wherein
the message is one of a plurality of messages provided by the sender, each with an associated time limit; and
the response includes automatically acquired audiovisual data for each of the messages based upon the associated time limit for each message.

4. The method according to claim 3, wherein
the automatically acquired audiovisual data for each of the messages comprises automatically beginning recording of the response upon completion of each message of the plurality of messages and automatically terminating the recording of the response after the associated time limit for the message of the plurality of messages has elapsed.

5. The method according to claim 1, wherein
the response data acquired is at least one of audiovisual data, image data, and text data.

6. A method comprising:
receiving at an electronic device comprising a microprocessor associated with a sender a plurality of messages generated by the sender, each message of the plurality of messages having an associated time limit established by the sender;
receiving upon the electronic device data relating to a plurality of contacts selected by the user;
transmitting to a plurality of contacts a message, the message comprising the plurality of messages;
receiving from a predetermined subset of the plurality of contacts responses, each response from a contact within the predetermined subset of the plurality of contacts generated upon an electronic device associated with the contact upon presentation of the plurality of messages and comprising response data automatically acquired with the electronic device for each message of the plurality of messages for its associated time limit; and
presenting the responses from the predetermined subset of the plurality of contacts responses to the sender.

7. The method according to claim 6, wherein
recording of each response begins automatically upon completion of at least one of the message and a predetermined portion of the message to a contact of the predetermined subset of the plurality of contacts.

8. The method according to claim 6, further comprising
transmitting with the message a predetermined time limit set by the sender by which responses should be provided; and
the predetermined subset of the plurality of contacts are those contacts within the plurality of contacts who respond within the predetermined time limit.

9. The method according to claim 6, wherein
each message of the plurality of messages comprises at least one of a text based message, an audio message, a video message, and an image associated with a text message or audio message.

10. The method according to claim 6, wherein
the response data acquired is at least one of audiovisual data, image data, and text data.

11. A method comprising:
receiving at an electronic device comprising a microprocessor associated with a recipient a plurality of messages generated by the sender, each message of the plurality of messages having an associated time limit established by the sender;
generating a plurality of responses, each response being stored upon the electronic device and comprising audiovisual data acquired automatically by the electronic device after the presentation of each message of the plurality of messages to the recipient with a maximum length of acquired response data associated with a specific message of the plurality of messages being the associated time limit for that message; and
transmitting the plurality of responses from the predetermined subset of the plurality of contacts responses to at least one of a remote server and the sender.

12. The method according to claim 11, wherein
recording of each response of the plurality of responses begins automatically upon completion of at least one of the message and a predetermined portion of the message.

13. The method according to claim 11, further comprising
receiving with the plurality of messages a predetermined time limit set by the sender by which responses should be provided.

14. The method according to claim 11, wherein
each message of the plurality of messages comprises at least one of a text based message, an audio message, a video message, and an image associated with a text message or audio message.

15. The method according to claim 11, wherein
the response data acquired is at least one of audiovisual data, image data, and text data.

16. A method of validating a financial transaction comprising:
receiving at an electronic device associated with a user making a purchase a prompt from a third party performing the financial transaction as part of the purchase, the prompt including a time limit associated with a response to be provided by the user;
automatically acquiring with the electronic device a response comprising response data upon the electronic device upon presentation of the prompt to the user, the response provided by the user for a period of time up to the time limit; and
transmitting from the electronic device the response to a recipient.

17. The method according to claim 16, wherein
recording of each response begins automatically upon presentation of the prompt.

18. The method according to claim 16, wherein
the response is audiovisual; and
the response data is at least one of an audiovisual data file and geolocation data.

19. The method according to claim 16, wherein
at least one of:
the response is stored in association with point of sale data relating to the purchase; and
the response is processed by the recipient to determine whether the user authorises the financial transaction.
